(19) United States
(12) Patent Application Publication
(10) Pub. No.: US 2013/0080693 A1
(43) Pub. Date: Mar. 28, 2013

(54) HYBRID MEMORY DEVICE, COMPUTER SYSTEM INCLUDING THE SAME, AND METHOD OF READING AND WRITING DATA IN THE HYBRID MEMORY DEVICE

(71) Applicants: Dong-Hwi Kim, Yongin-si (KR); Sun-Young Lim, Seoul (KR)

(72) Inventors: Dong-Hwi Kim, Yongin-si (KR); Sun-Young Lim, Seoul (KR)

(21) Appl. No.: 13/590,284

(22) Filed: Aug. 21, 2012

(30) Foreign Application Priority Data
Sep. 23, 2011 (KR) 10-2011-0096563

(51) Int. Cl. G06F 12/00

(52) U.S. Cl. 711/105; 711/E12.001

(57) ABSTRACT

A hybrid memory device includes a DRAM and a non-volatile memory. When a program is executed for the first time by a central processing unit (CPU), and data is copied to the DRAM from an external memory device, the data is also copied to the non-volatile memory. The non-volatile memory is configured to directly output data stored therein to an exterior without passing through the DRAM.

### CROSS-REFERENCE TO RELATED APPLICATION

This application claims priority under 35 U.S.C. §119 to Korean Patent Application No. 10-2011-0096563 filed on Sep. 23, 2011, in the Korean Intellectual Property Office (KIPO), the disclosure of which is incorporated by reference herein.

### TECHNICAL FIELD

Embodiments of the inventive concept relate to a hybrid memory device and a computer system including the hybrid memory device.

### DISCUSSION OF RELATED ART

A memory may be a volatile memory or a non-volatile memory. Volatile memory, also known as volatile storage, is memory that requires power to maintain stored information. Non-volatile memory is memory that can retain stored information even when not powered. Examples of volatile memory include random access memory (RAM) and static RAM (SRAM). Examples of non-volatile memory include read only memory (ROM) and flash memory.

### SUMMARY

At least one embodiment of the inventive concept provides a hybrid memory device that operates at high speed in a read and write mode and has a small package.

At least one embodiment of the inventive concept provides a computer system that includes the hybrid memory device.

At least one embodiment of the inventive concept provides methods of reading data from the hybrid memory device and writing data to the hybrid memory device.

According to an exemplary embodiment of the inventive concept, a hybrid memory device includes a DRAM and a non-volatile memory (NVM). When a program is executed for the first time by a central processing unit (CPU), and data is copied to the DRAM from an external memory device, the data is also copied to the non-volatile memory. The non-volatile memory is configured to directly output data stored therein outside the device without passing through the DRAM.

In an embodiment, the non-volatile memory is a PRAM or an RRAM.

In an embodiment, the hybrid memory device is a memory module implemented in the form of a multi-chip package (MCP).

In an embodiment, the hybrid memory device is a stacked memory device in which the DRAM and the non-volatile memory are stacked three-dimensionally.

In an embodiment, the DRAM and the non-volatile memory are electrically connected by a through-silicon-via (TSV).

According to an exemplary embodiment of the inventive concept, a computer system includes a central processing unit (CPU) and a hybrid memory device. The hybrid memory device includes a DRAM and a non-volatile memory device (NVM). The CPU is configured to copy data to the DRAM from an external memory device and copy the data to the non-volatile memory when a program is executed for the first time by the CPU. The non-volatile memory is configured to directly output data stored therein outside without passing through the DRAM.

In an embodiment, a virtual memory manager is configured to copy data from the external memory device to the DRAM, and renew a main-page table.

In an embodiment, when an address of the non-volatile memory and a virtual memory address of a program are directly linked together through the main-page table, the main-page table includes a read-only mark.

In an embodiment, the read-only mark is configured to prevent data from being directly written in a space corresponding to an address of the non-volatile memory.

In an embodiment, a sub-page table indicating that the data is stored in the non-volatile memory is configured to be established in the non-volatile memory.

In an embodiment, the sub-page table is established in the external memory.

In an embodiment, when a program execution is not a first time execution, the CPU first checks the non-volatile memory before checking the external memory device to obtain data required for the program execution.

In an embodiment, the computer system generates a page-fault, and assigns a physical address of the DRAM to a virtual memory address when a write request to the virtual memory address that is linked to the non-volatile memory is received in a write mode.

In an embodiment, the computer system generates the page-fault by referring to the read-only mark of the main-page table.

In an embodiment, data of the non-volatile memory that is linked to a virtual memory address is renewed when data of the external memory device is renewed.

According to an exemplary embodiment of the inventive concept, a method of reading data in a hybrid memory device includes determining whether a program has been executed for the first time, and when the program is executed for the first time, assigning a space of a DRAM and a non-volatile memory to a virtual memory address, and copying data from an external memory device to the DRAM and the non-volatile memory.

In an embodiment, the method of reading data in a hybrid memory device may further include renewing a main-page table (MPT), establishing a sub-page table (SPT) indicating that the data is stored in the non-volatile memory, reading the data from a region of the DRAM corresponding to an address that is received from a central processing unit (CPU), and transmitting the read data to the CPU.

In an embodiment, the method of reading data in a hybrid memory device may further include when a program execution is not a first time execution, transferring a control right from a virtual memory manager to a file system, referring to the sub-page table (SPT) using the file system, confirming that data is stored in the non-volatile memory, and transferring the control right from the file system to the virtual memory manager.

In an embodiment, confirming that data is stored in the non-volatile memory may be executed by the file system using an entry of the sub-page table (SPT).

In an embodiment, the method of reading data in a hybrid memory device may further include linking the virtual memory address to a corresponding address of the non-volatile memory by renewing the main-page table (MPT), reading the data from a region of the non-volatile memory corresponding to an address received from a central processing unit (CPU), and transferring the read data to the CPU.

In an embodiment, linking the virtual memory address to a corresponding address of the non-volatile memory by renewing the main-page table (MPT) may be executed by the virtual memory manager.

According to an exemplary embodiment of the inventive concept, a method of writing data in a hybrid memory device includes executing a writing operation to write data into a virtual memory address linked to a non-volatile memory, assigning a new physical memory address to the virtual memory address when the writing operation fails, copying data stored in the non-volatile memory to store in a DRAM, renewing a main-page table (MPT), and executing a writing operation to write data into a virtual memory address linked to the DRAM.

In an embodiment, the method of writing data in a hybrid memory device does not renew a sub-page table (SPT) in executing a writing operation to write data into the virtual memory address linked to a non-volatile memory.

In an embodiment, the method of writing data in a hybrid memory device further includes executing a writing operation to write data into an external memory device, and renewing data of the non-volatile memory.

According to an exemplary embodiment of the inventive concept, a computer system includes a central processing unit CPU and a hybrid memory device having a volatile memory device and a non-volatile memory device. The CPU is configured to copy data into the non-volatile memory when the data is copied into the volatile memory from an external device and the CPU executes a program for the first time. The hybrid memory device is configured to read data from the volatile memory to execute the program the first time. The hybrid memory device is configured to read data from the non-volatile memory device to execute the program a second time.

In an embodiment, the non-volatile memory is configured to output data stored therein outside the hybrid memory device without passing through the volatile memory. In an embodiment, the hybrid memory includes a substrate layer, a first layer disposed on top of the substrate layer and comprising the volatile memory, and a second layer disposed on top of the first layer and comprising the non-volatile memory. The computer system may further include a first plurality of silicon vias disposed between the substrate layer and the first layer to enable communication between the substrate layer and the volatile memory and a second plurality of silicon vias disposed between the first layer and the second layer to enable communication between the volatile memory and the non-volatile memory. The computer system may include a first bus configured to communicate commands and addresses from the CPU to the hybrid memory device, a second bus configured to exchange data between the CPU and the hybrid memory, and a third bus configured to communicate a clock signal from the CPU to the hybrid memory. In an embodiment, the CPU is configured to assign a space of the volatile memory to a virtual memory address and assign a space of the non-volatile memory to the same virtual memory address when the CPU executes the program the first time.

### BRIEF DESCRIPTION OF THE DRAWINGS

Exemplary embodiments of the inventive concept are described in further detail below with reference to the accompanying drawings. The drawings may not be to scale. In the drawings:

FIG. 1 is a block diagram illustrating a computer system including a hybrid memory device according to an exemplary embodiment of the inventive concept;

FIG. 2 is a block diagram illustrating a process of data communication among circuit blocks included in the computer system of FIG. 1 according to an exemplary embodiment of the inventive concept;

FIG. 3 is a flowchart illustrating a method of reading data in a hybrid memory device according to an exemplary embodiment of the inventive concept;

FIGS. 4 and 5 are flowcharts illustrating methods of writing data in a hybrid memory device according to exemplary embodiments of the inventive concept;

FIG. 6 is a perspective view illustrating an example of a hybrid memory device that may be included in the computer system of FIG. 1 according to an exemplary embodiment of the inventive concept; and

FIG. 7 is a block diagram illustrating a computer system including a hybrid memory device according to an exemplary embodiment of the inventive concept.

### DETAILED DESCRIPTION

The inventive concept will now be described more fully with reference to the accompanying drawings in which exemplary embodiments thereof are shown. These inventive concepts may, however, be embodied in different forms and should not be construed as limited to the embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numerals refer to like elements throughout. As used herein, the singular forms “a,” “an” and “the” are intended to include the plural forms as well, unless the context clearly indicates otherwise.

Embodiments of the inventive concept will now be described with reference to the accompanying drawings.

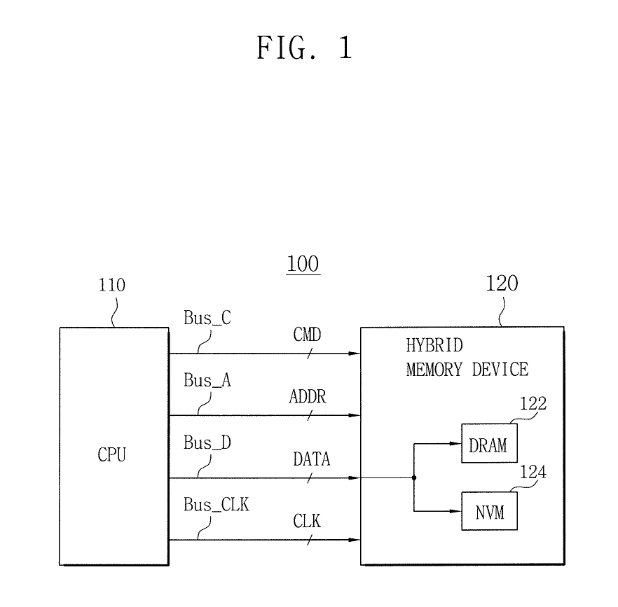

FIG. 1 is a block diagram illustrating a computer system 100 including a hybrid memory device according to an exemplary embodiment of the inventive concept.

Referring to FIG. 1, the computer system 100 includes a central processing unit (CPU) 110 and a hybrid memory device 120.

The CPU 110 generates a command CMD, an address ADDR, data DATA and a clock signal CLK. The hybrid memory device 120 receives the command CMD from the CPU 110 through a command bus Bus_C, receives the address ADDR from the CPU 110 through an address bus Bus_A, receives the data DATA from the CPU 110 through a data bus Bus_D, and receives the clock signal CLK from the CPU 110 through a clock bus BUS_CLK. In an embodiment, each of the bus lines shown in FIG. 1 is a distinct electrical line. The hybrid memory device 120 writes data into a memory space corresponding to the address ADDR, or reads data from a memory space corresponding to the address ADDR to transmit to the CPU 110. For example, the address ADDR may indicate a location within the hybrid memory device 120 in which data is to be written to or read from. In an embodiment, the hybrid memory device 120 includes a dynamic random-access memory (DRAM) 122 and a non-volatile memory (NVM) 124. Though not shown in FIG. 1, external memory devices such as a hard-disk drive (HDD) and/or a solid-state drive (SSD) may be connected to the CPU 110.

In an embodiment of the computer system 100, when a program is executed for the first time by the CPU 110, and data is copied to the DRAM 122 from an external memory device, the data is also copied to the NVM 124.

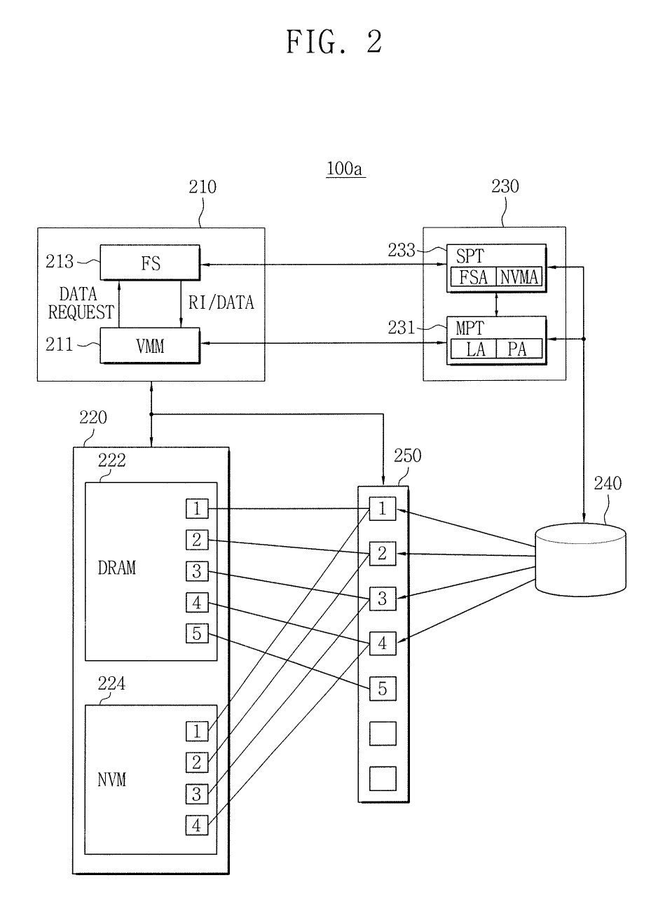

FIG. 2 is a block diagram illustrating a process of data communication among circuit blocks included in the computer system of FIG. 1 according to an exemplary embodiment of the inventive concept.

Referring to FIG. 2, the computer system 100a includes an operating system (OS) 210, a hybrid memory device 220, a page table 230, an external memory device 240 and a virtual memory space 250. In an embodiment, the OS 210 and the virtual memory space 250 are included in the CPU 110 of FIG. 1.

In an embodiment, the OS 210 includes a virtual memory manager (VMM) 211 and a file system (FS) 213, and the page table 230 includes a main-page table (MPT) 231 and a sub-page table (SPT) 233. In an embodiment, the MPT 231 includes a logical address LA and a physical address PA, and the SPT 233 includes a file system address FSA and an NVM address NVMA. The virtual memory manager 211 provides a data request DATA REQUEST to the file system 213, and the file system 213 provides information RI or data DATA in response to the data request. For example, the external memory device 240 may be a hard disk drive (HDD) or a solid state drive (SSD).

The hybrid memory device 220 may include a DRAM 222 and an NVM 224. Each of the DRAM 222 and the NVM 224 may be separate semiconductor chips, and the hybrid memory device 220 may be a multi-chip package (MCP). The DRAM 222 may be a volatile memory. In alternate embodiments, the DRAM 222 is replaced with another type of volatile memory.

When a program is executed for the first time by the CPU 210, and data is copied to the DRAM 222 from an external memory device (e.g., 240), the data is also copied to the NVM 224. For example, a first execution of the program could result in calculation of a value that is stored into the external memory device 240, and then this value can be copied to the DRAM 222 and the NVM 224. Data in the NVM 224 may be directly output to the exterior without passing through the DRAM 222.

Hereinafter, an operation of the computer system 100 that includes the hybrid memory device 120 shown in FIG. 1 will be described referring to FIG. 1 and FIG. 2.

The hybrid memory device 220 in FIG. 2 corresponds to the hybrid memory device 120 shown in FIG. 1. The hybrid memory device 220 may include the DRAM 222 and the NVM 224.

When a program is executed for the first time by the CPU 110, and data is copied to the DRAM 222 from an external memory device 240, the data is also copied to the NVM 224. Copying the data from the external memory device 240 to the NVM 224 may be executed as a background operation, without giving notice to a user. Data in the NVM 224 may be directly output to the exterior without passing through the DRAM 222.

Referring to FIG. 2, when a program is executed for the first time by the CPU 110, the virtual memory manager 211 assigns a space or section of the DRAM 222 to the virtual memory address 1, 2, 3 and 4 of the virtual memory space 250, copies data from the external memory device 240 to the DRAM 222, and renews the main-page table 231. Further, the virtual memory manager 211 assigns a space or section of the NVM 224 to the virtual memory address 1, 2, 3 and 4 of the virtual memory space 250, and copies data from the external memory device 240 to the NVM 224. Use of virtual memory addresses 1-4 is merely an example, as different and non-contiguous memory addresses may be used, and a lesser or greater number of virtual memory addresses may be used when the program is executed.

In an embodiment, a sub-page table (SPT) 233 indicating that the data has been copied to the NVM 224 is established. In an embodiment, the file system 213 is capable of confirming that data is stored in the NVM 224 by checking the sub-page table 233.

When the program execution is not a first time execution and the program requests that the virtual memory manager 211 provide physical memory space, the virtual memory manager 211 transfers a control right to the file system 213. The file system 213 confirms whether data is stored in the NVM 224 by referring to the sub-page table 233. If the file system 213 is able to confirm that the data is stored in the NVM 224, the file system 213 transfers the control right to the virtual memory manager 211.

In an embodiment, instead of assigning physical memory (e.g., a space or section of the DRAM 222) to the data, the virtual memory manager 211 links a virtual memory address assigned to the program to an address of the NVM 224 by renewing the main-page table 231. In an embodiment, the data of the NVM 224 is output to the CPU 110 without passing through the DRAM 222, and the computer system 100 executes a program using data of the NVM 224.

Therefore, when the program execution is not a first time execution, data may be copied from the external memory device 240 to the DRAM 222 more quickly. In an embodiment where the NVM 224 is directly linked to a virtual memory address of the program through the main-page table 231, a read-only mark is included in the main-page table 231. In this way, a later writing of data directly into the NVM 224 may be prevented and the life of the NVM 224 may be improved.

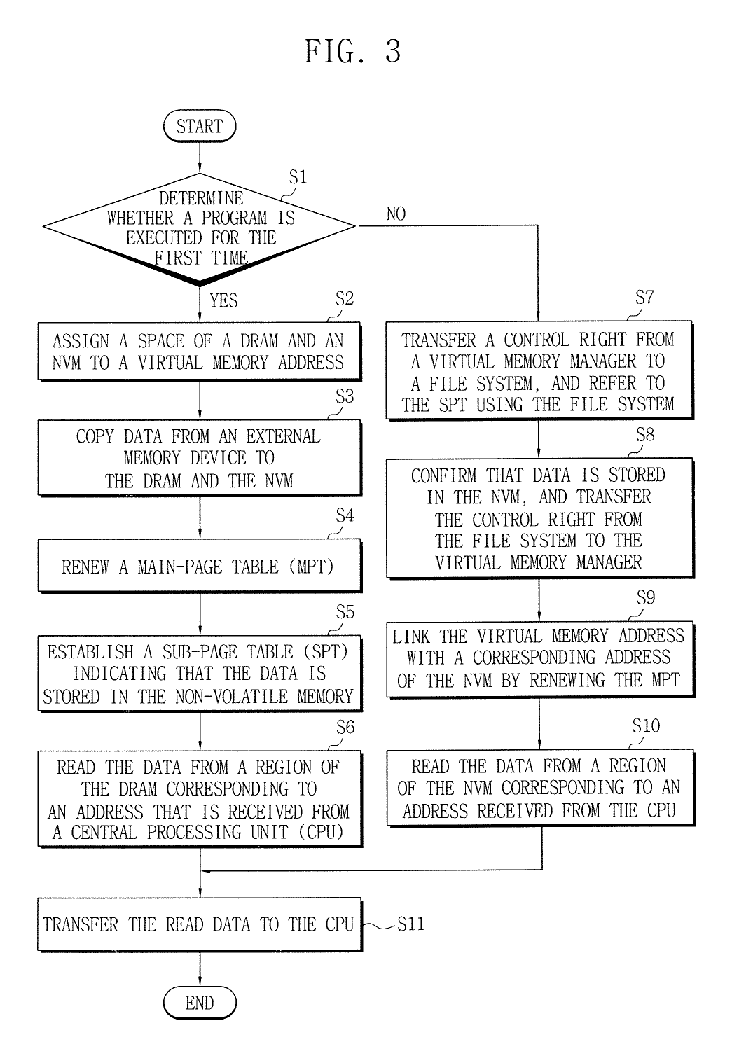

FIG. 3 is a flowchart illustrating a method of reading data in a hybrid memory device according to an exemplary embodiment of the inventive concept.

Referring to FIG. 3, a method of reading data in a hybrid memory device includes determining whether a program is executed for the first time (S1). If the program has been executed for the first time, the method assigns a space (or section) of a DRAM and an NVM to a virtual memory address (S2), copies data from an external memory device to the DRAM and the NVM (S3), renews a main-page table (MPT) (S4), establishes a sub-page table (SPT) indicating that the data is stored in the non-volatile memory (S5), reads the data from a region of the DRAM corresponding to an address that is received from a central processing unit (CPU) (S6), and transfers the read data to the CPU (S11).

When a program execution is not a first time execution, the method transfers a control right from a virtual memory manager to a file system, and refers to the sub-page table (SPT) using the file system (S7), confirms that data is stored in the NVM, and transfers the control right from the file system to the virtual memory manager (S8), links the virtual memory address to a corresponding address of the NVM by renewing the main-page table (MPT) (S9), reads the data from a region of the NVM corresponding to an address received from a central processing unit (CPU) (S10), and transfers the read data to the CPU (S11).

When the data is read from the NVM it can also be output to the exterior without being stored to the DRAM. Confirming that data is stored in the NVM may be executed by the file system using an entry of the sub-page table (SPT). Linking the virtual memory address to a corresponding address of the NVM by renewing the main-page table (MPT) may be executed by the virtual memory manager.

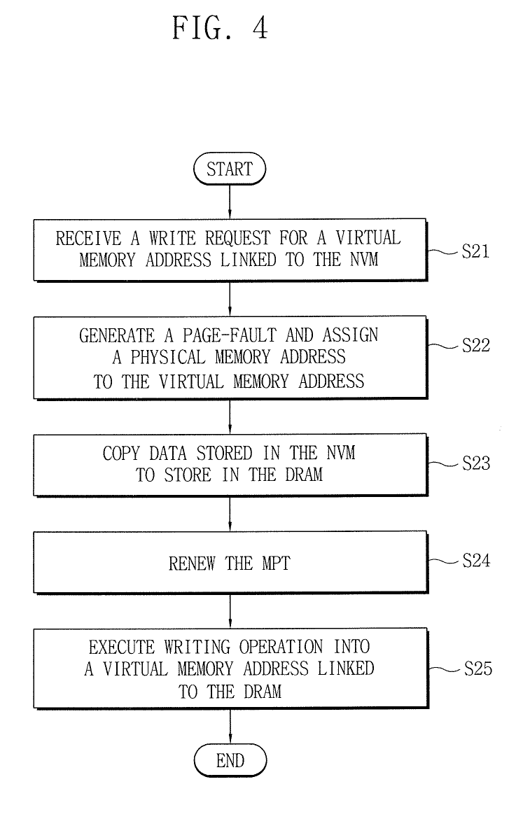

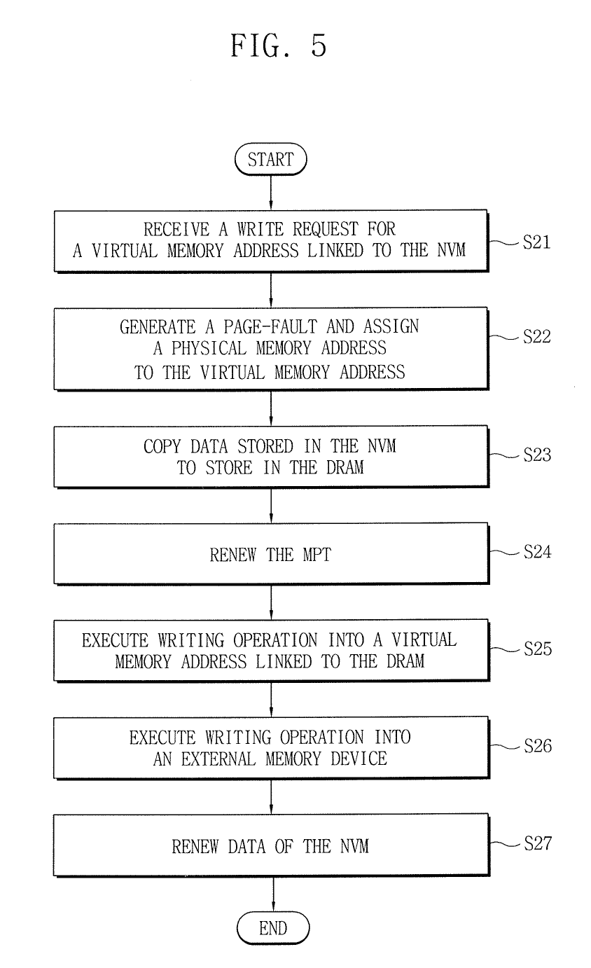

FIGS. 4 and 5 are flowcharts illustrating methods of writing data to a hybrid memory device according to exemplary embodiments of the inventive concept.

Data used by a computer system may be data that a new address is assigned and temporarily generated and written. Data that is used to renew a former address needs to be preserved when a program is processing, but need not be preserved after the program has ended.

In an example where data that a new address is assigned and temporarily generated and written is erased when the program has ended or when the program is processing, the virtual memory manager (VMM) assigns a region of the DRAM for the data.

In an example where data that is used to renew a former address, which needs to be preserved when a program is processing, but need not be preserved when the program has ended, a method of writing data to a hybrid memory device may include operations shown in FIG. 4.

Referring to FIG. 4, a method of writing data to a hybrid memory device according to an exemplary embodiment of the inventive concept includes receiving a write request for a virtual memory address linked to the NVM (S21), generating a page-fault and assigning a physical memory address to the virtual memory address (S22), copying data stored in the NVM to store in the DRAM (S23), renewing a main-page table (MPT) (S24), and executing a writing operation to write data into a virtual memory address linked to the DRAM (S25).

In an embodiment, the method of writing data to a hybrid memory device does not renew a sub-page table (SPT) when executing a writing operation to write data into the virtual memory address linked to a non-volatile memory.

In an example where data that is used to renew a former address, which needs to be preserved when a program is processing or after the program has ended, a method of writing data to a hybrid memory device may include operations shown in FIG. 5.

Referring to FIG. 5, a method of writing data to a hybrid memory device according to an exemplary embodiment of the inventive concept includes receiving a write request for a virtual memory address linked to the NVM (S21), generating a page-fault and assigning a physical memory address to the virtual memory address (S22), copying data stored in the NVM to store in the DRAM (S23), renewing a main-page table (MPT) (S24), executing a writing operation to write data into a virtual memory address linked to the DRAM (S25), executing a writing operation to write data to an external memory device (S26), and renewing data of the NVM (S27).

As shown in FIG. 5, when data that is used to renew a former address, which needs to be preserved when a program is processing or after the program has ended, a method of writing data to a hybrid memory device may further include executing a writing operation to write data into an external memory device (S26), and renewing data of the NVM (S27).

A computer system including a hybrid memory device according to an exemplary embodiment of the inventive concept assigns space in an external memory device to perform a swap-out using a file system (FS) during a program execution. In a later operation, when the swap-out is to be performed again for the data in the external memory device, the computer system temporarily adds a bypass bit in a corresponding address of the sub-page table (SPT) before the swap-out to prevent the file system (FS) from fetching data previously stored in the NVM by referring to the sub-page table (SPT). Then the bypass bit may be erased when the program has ended.

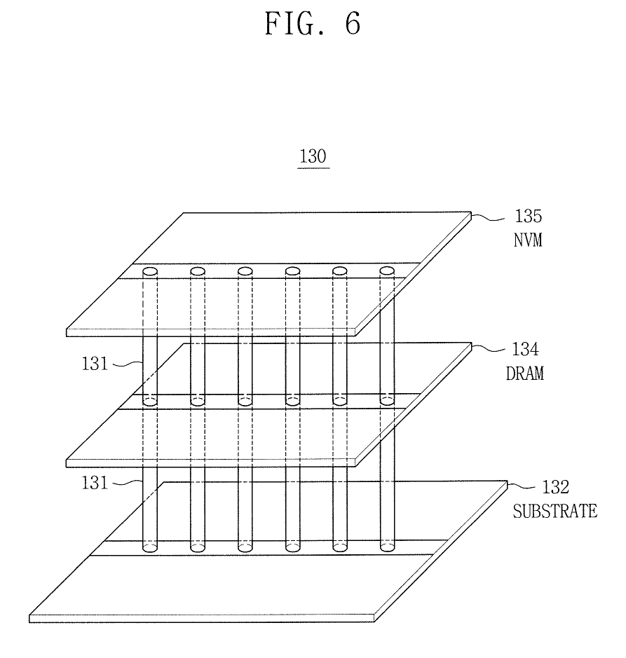

FIG. 6 is a perspective view illustrating an example of a hybrid memory device that may be included in the computer system 100 of FIG. 1.

Referring to FIG. 6, a hybrid memory device 130 includes a DRAM 134, an NVM 135 and a substrate 132.

The hybrid memory device 130 is a stacked memory device in which the DRAM 134 and the NVM 135 are three-dimensionally stacked on the substrate 132. Each of the layers (semiconductor chips) may be electrically connected through a plurality of through-silicon-vias (TSVs) 131 that are inter-layer connecting units.

As shown in FIG. 6, when semiconductor chips are three-dimensionally stacked, the area of the semiconductor device in a system may be decreased.

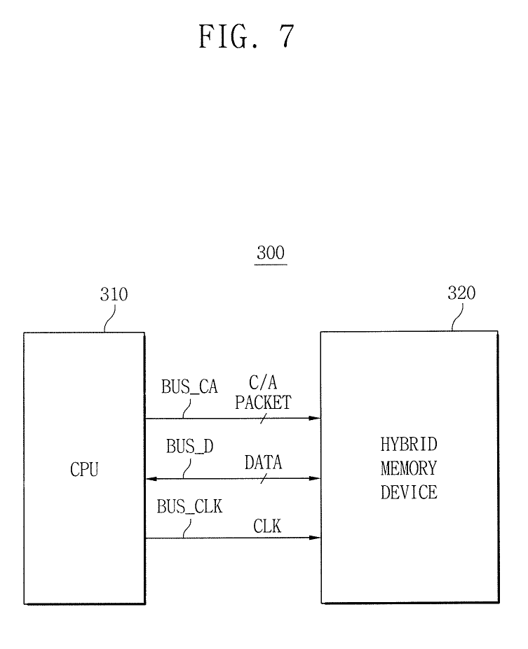

FIG. 7 is a block diagram illustrating a computer system 300 including a hybrid memory device according to an exemplary embodiment of the inventive concept.

Referring to FIG. 7, the computer system 300 includes a central processing unit (CPU) 310 and a hybrid memory device 320.

The CPU 310 generates a command/address packet C/A PACKET in which a command CMD and an address ADDR are combined together, data DATA and a clock signal CLK. The hybrid memory device 320 receives the command/address packet C/A PACKET, the data DATA and the clock signal CLK from the CPU 310 through a command/address bus BUS_CA, a data bus BUS_D and a clock bus BUS_CLK, respectively. The hybrid memory device 320 writes data into a memory space or section corresponding to the address ADDR, or reads data from a memory space or section corresponding to the address ADDR. The read data is transmitted to the CPU 310 and the data that is written, is received from the CPU 310. The hybrid memory device 320 may include a DRAM 222 and an NVM 224 as shown in FIG. 2.

Though not drawn in FIG. 1, external memory devices such as a hard-disk drive (HDD) and a solid-state drive (SSD) may be connected to the CPU 310.

The NVM included in the hybrid memory devices 120, 220 and 320 may be a phase-change memory (PRAM), resistive random-access memory (RRAM), a flash memory, etc. A PRAM is a resistive memory device that uses a phase change material as a variable resistor, and an RRAM is a resistive memory device that uses a transition metal oxide as a variable resistor. The flash memory device is a kind of non-volatile memory device, and has a floating gate and changes a threshold voltage by adjusting a voltage applied to a control gate.

The above has described an embodiment of a hybrid memory device including one DRAM and one NVM. However, embodiments of the inventive concept are not limited thereto. For example, the hybrid memory device may include a plurality of DRAM and a plurality of NVM. Further, the hybrid memory device may include an SRAM instead of DRAM as a volatile memory, or any other type of volatile memory.

At least one embodiment of the inventive concept is applied to a memory device using a multi-chip package, and a computer system including the memory device.

A hybrid memory device according to an exemplary embodiment of the inventive concept includes a DRAM and a non-volatile memory (NVM), and also copies data into the non-volatile memory when the data is copied from an external memory device into the DRAM. When a program is to be executed a second time, the hybrid memory device reads data from the NVM to execute the program.

Accordingly, a hybrid memory device according to at least one embodiment of the inventive concept may perform read and write operations at a higher rate and use less power. Further, a hybrid memory device according to at least one embodiment of the inventive concept may be configured to have a smaller capacity as compared to a memory device having only a DRAM.

Although exemplary embodiments of the inventive concept have been described, many modifications can be made to these embodiments without departing from the inventive concept. Accordingly, all such modifications are intended to be included in the scope of the inventive concept. Therefore, it is to be understood that the foregoing is illustrative of various embodiments and is not to be construed as limited to the specific embodiments disclosed, and that modifications to the disclosed embodiments, as well as other embodiments, are intended to be included in the scope of the inventive concept.

What is claimed is:

1. A hybrid memory device comprising:
a dynamic random-access memory (DRAM); and
a non-volatile memory,
wherein when a program is executed for the first time by a central processing unit (CPU), and data is copied to the DRAM from an external memory device, the data is also copied to the non-volatile memory, and
wherein the non-volatile memory is configured to output data stored therein outside the device without passing through the DRAM.

2. The hybrid memory device according to claim 1, wherein the non-volatile memory includes a phase-change memory (PRAM) or a resistive random-access memory (RRAM).

3. The hybrid memory device according to claim 1, wherein the hybrid memory device includes a memory module implemented in the form of a multi-chip package (MCP).

4. The hybrid memory device according to claim 1, wherein the hybrid memory device includes a stacked memory device, wherein the DRAM and the non-volatile memory are stacked three-dimensionally.

5. The hybrid memory device according to claim 4, wherein the DRAM and the non-volatile memory are configured to be electrically connected by a through-silicon-via (TSV).

6. A computer system comprising:
a central processing unit (CPU);
a dynamic random-access memory (DRAM); and
a non-volatile memory device (NVM),
wherein the CPU is configured to copy data to the DRAM from an external memory device and copy the data to the non-volatile memory when a program is executed for the first time by the CPU, and
wherein the NVM is configured to output data stored therein outside without passing through the DRAM.

7. The computer system according to claim 6, wherein a virtual memory manager is configured to copy data from the external memory device to the DRAM, and renew a main-page table.

8. The computer system according to claim 7, wherein when an address of the NVM and a virtual memory address of a program are directly linked together through the main-page table, the main-page table is configured to include a read-only mark.

9. The computer system according to claim 8, wherein the read-only mark is configured to prevent data from being directly written in a space corresponding to an address of the NVM.

10. The computer system according to claim 7, wherein a sub-page table indicating that the data is stored in the non-volatile memory is configured to be established in the NVM.

11. The computer system according to claim 10, when a program execution is not a first time execution, the CPU is configured to first check the non-volatile memory before checking the external memory device to obtain data required for the program execution.

12. The computer system according to claim 7, wherein the computer system is configured to generate a page-fault, and to assign a physical address of the DRAM to a virtual memory address when a write request to the virtual memory address that is linked to the NVM is received in a write mode.

13. The computer system according to claim 12, wherein the computer system is configured to generate the page-fault by referring to a read-only mark of the main-page table.

14. The computer system according to claim 6, wherein data of the non-volatile memory that is linked to a virtual memory address is configured to be renewed when data of the external memory device is renewed.

15. A computer system comprising:
a central processing unit (CPU); and
a hybrid memory device comprising a volatile memory and a non-volatile memory,
wherein the CPU is configured to copy data into the non-volatile memory when the data is copied into the volatile memory from an external device and the CPU executes a program for the first time,
wherein the hybrid memory device is configured to read data from the volatile memory to execute the program the first time, and
wherein the hybrid memory device is configured to read data from the non-volatile memory to execute the program a second time.

16. The computer system of claim 15, wherein the non-volatile memory is configured to output data stored therein outside the hybrid memory device without passing through the volatile memory.

17. The computer system of claim 15, wherein the hybrid memory device comprises:
a substrate layer;
a first layer disposed on top of the substrate layer and comprising the volatile memory; and
a second layer disposed on top of the first layer and comprising the non-volatile memory.

18. The computer system of claim 17, further comprising:
a first plurality of silicon vias disposed between the substrate layer and the first layer to enable communication between the substrate layer and the volatile memory; and
a second plurality of silicon vias disposed between the first layer and the second layer to enable communication between the volatile memory and the non-volatile memory.

19. The computer system of claim 15, further comprising:
a first bus configured to communicate commands and addresses from the CPU to the hybrid memory device;
a second bus configured to exchange data between the CPU and the hybrid memory device; and
a third bus configured to communicate a clock signal from the CPU to the hybrid memory device.

20. The computer system of claim 15, wherein the CPU is configured to assign a space of the volatile memory to a virtual memory address and assign a space of the non-volatile memory to the same virtual memory address when the CPU executes the program the first time.
